(19) United States
(12) Patent Application Publication
(10) Pub. No.: US 2010/0263019 A1
(43) Pub. Date: Oct. 14, 2010

(54) SECURE EXCHANGE OF MESSAGES

(75) Inventor: Trond Lemberg, Skotbu (NO)

Correspondence Address: SCHNECK & SCHNECK, P.O. BOX 2-E, SAN JOSE, CA, 95109-0005, US

(73) Assignee: MESSAGE MANAGEMENT AS, Skotbu (NO)

(21) Appl. No.: 12/675,599

(22) PCT Filed: Aug. 29, 2008
(86) PCT No.: PCT/NO08/00306

§ 371 Date: Apr. 22, 2010

(30) Foreign Application Priority Data
Aug. 29, 2007 (NO) 20074384

(51) Int. Cl. G06F 21/00; G06F 15/16

(52) U.S. Cl. 726/1

(57) ABSTRACT

An arrangement for declaration of security level of transport paths/routes in one or more data networks where the arrangement at least comprises: an entity (3) configured to interrogate nodes in said at least one data network with respect to said nodes security level and/or said nodes possessed certificates, at least one database where said database comprises information about strength of certificates and issuers' of certificates, at least a mechanism configured to retrieve information from domain name servers (2), and an interface configured to receive request for declaration from one or more senders (1). The present invention also discloses a corresponding method for declarations of security level of transport paths/routes in one or more data networks.

### TECHNICAL FIELD

The present invention discloses a method and an arrangement related to security mechanisms for message based electronic transactions; specifically the use of the protocol TLS—Transport Layer Security to establish a dynamically secure route to in principle any independent parties. In addition the invention relates to the determination of the quality level of such a route, based on assessments of the TLS certificate, IP address, domain name, server name etc in place on the receiving site.

### BACKGROUND ART

Encryption (proof of confidentiality) is crucial to many message applications and services in the electronic world. Today, this is mainly accomplished by firm and closed user groups where the same cryptographic software and/or hardware must be deployed among defined communicating parties before secure messaging can take place.

This is the main obstacle for users that have a need for instantly available secure communication towards any random and independent party, and therefore must lean on a mechanism that dynamically declare secure routes between the sender and the recipients before messages are sent.

Where messaging services on the sending site has the ability to take advantage of TLS connections towards receiving messaging services, it serves senders without a defined quality of protection, since it only uses what currently is available on the receiving site. If the TLS connection is not possible to establish, messages is by default sent in clear text without any mechanism of alternate protection, such as halting the message, or warning the sender before sending or offering a secure re-routing etc.

Fundamentally, the problem addressed by the present invention is the lack of information with respect to the level of security/confidentiality feedback given to any sender of electronic messages. Even though a receiving party seems to offer a secure service through its message receiving server, the sender cannot necessarily rely on the intermediate nodes/servers. A message from a sender may be composed of several packets of data, where different packets are routed through the networks on different paths; hence the level of security between the sender and the receiving party may vary even within one message. You may be “lucky” one day, whereas the next day due for example to congested networks you will experience that your message is transferred via insecure nodes. It is self explanatory that senders with a need to transfer sensitive data cannot live with these uncertainties.

There is not only a lack of feedback; it is further a lack of control for the sender. A receiving party may, as indicated above, be “secure”, however due to congested networks or for other reasons messages may take an “insecure” route through the network, this leaves the uneducated sender with a confidence that the message transfer where secure, whereas it was not. It should have been mechanisms that enable the sender to halt messages in cases where a secure route cannot be guarantied. Furthermore, packets of data with a “reserved” secure route shall not be routed via insecure nodes even though there is network congestion, in such situations it is better to leave packets in queues waiting for a secure path. Hence there is a need for network administration that enables routing of data packets according to required security level.

The main problems are:

Senders behind TLS based messaging services must know to whom message content (e.g. email) is transferred securely before using the messaging service.

Senders are not served by messaging services in order to assess the quality of protection, offered on the receiving site.

No requirements by the sender related to the quality of the TLS connection is taken into consideration.

Senders must manually or by other means investigate what kind of prerequisites the receiving parties have before sensitive content is transferred.

This lack of user friendliness paves the way of either leaking sensitive information to open networks by accident or prohibits the users to effectively take the advantages of using modern messaging technology for services that has a need for confidentiality.

An example of a familiar message exchange client is Microsoft Exchange Server 2007 which fully discloses problems related to secure messaging between parties. A scenario can be as follows:
If the sender has an email distribution list of receivers that is going to be used for the purpose of distributing confidential content, the Microsoft Exchange Server 2007 sends email over TLS where it is available and in clear text anywhere else.
If TLS connections is in use by Microsoft Exchange Server 2007 on behalf of users, no quality characteristics defined by the sender is taken into consideration. E.g. the sender requires a certificate of a certain quality level from a commercial trusted third party, as an alternate to, per dictate, accept a self-signed certificate issued by the receiving party, which is the standard method implemented in Microsoft Exchange Server 2007.

The discussion above clearly indicated the need for an improved administration of data packet transportation with security requirements. Furthermore it is a need to offer senders of sensitive data a solution with declared secure routes from sender to receivers.

### DISCLOSURE OF INVENTION

The object of the present invention is to overcome the problems described above by introducing a novel method and arrangement where a sender gets a declaration indicating a security level of one or more routes in a transport networks. Hence the present invention discloses a method and an arrangement related to security mechanisms for message based electronic transactions; specifically the use of the protocol TLS—Transport Layer Security to establish a dynamically secure route to in principle any independent parties. In addition the invention relates to the determination of the quality level of such a route, based on assessments of the TLS certificate, IP address, domain name, server name etc in place on the receiving site.

Other advantages and features characteristics of the invention will become apparent by the appended claims.

### BRIEF DESCRIPTION OF FIGURES IN THE DRAWINGS

For a better understanding of the invention, reference is made to the following description and to the accompanying drawings wherein:

FIG. 1 is a simple diagram showing TLS declaration.

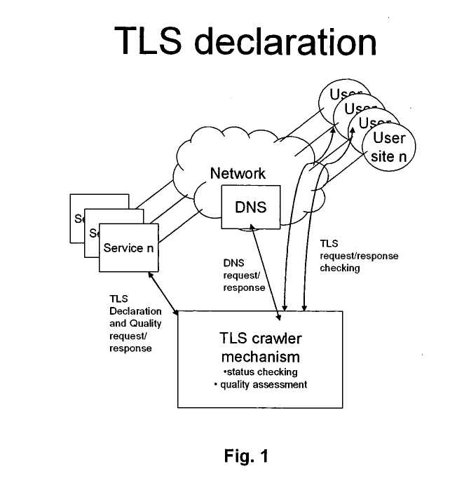

FIG. 2 is a block diagram of a request and response model according to one embodiment of the present invention.

### MODE(S) FOR CARRYING OUT THE INVENTION

For ease of understanding the present invention will now be described with reference to the figures. The figures are only included for illustrative purposes and are not meant to restrict the scope of protection, a person skilled in the art will appreciate other advantageous solutions as disclosed by the appending claims.

According to the present invention the arrangement includes at least an entity (3) configured to interrogate nodes in a data networks with respect to said nodes security level/said nodes certificates. That is, which certificate, if any, is possessed by the at least one interrogated node. Preferably the entity also comprises at least one database where said database includes information about the strength of certificates and issuers' of certificates. The entity further comprises a mechanism configured to retrieve information from domain name servers (2). The retrieved information from the DNS (2) servers can among others be information related to receiving servers or intermediate nodes and their types of certificates etc. The entity is further configured with an interface against one or more senders (1). The senders (1) are users of the service provided by the entity (3), which demands a declared level of security/confidentiality on their message exchange. So as to ease readability said entity (3) is hereinafter referred to as a TLS crawler, which is by no means meant to restrict the TLS crawler (3) to be a traditional web or database crawler.

The arrangement and method according to the present invention does not only provide information regarding level of security for transfer of data in data network between senders (1) and receivers (4), it also ensures a chosen level of security for the senders provided the chosen level is available. If the chosen level is not available due to congestion the sender (1) will be informed and given the choice of aborting the data transfer. He will not, as is common, experience that data transfer is halted, rerouted and forwarded via nodes that does not fulfill the criteria for security/confidentiality. For the sender the arrangement and method is seen as a service for quality assurance for the arrangement and method that establishes a tunnel for secure tunnelling of data between the endpoints (1,4).

In one scenario, Senders behind Sending Messaging Service 2—SMS2 (11) have a need of transferring sensitive content to Receivers behind Receiving Messaging Services 1—RMS1 (41) and Receiving Messaging Services 2—RMS2 (42).

SMS2 (11) wants to declare whether or not there exists a secure TLS route to both RMS1 (41) and RMS2 (42) with an acceptable quality level. The SMS2 (11) has no knowledge of the quality level at the receiving sites, since they are random and independent parties. To decide on the applicability of the secure messaging service, if any, the SMS2 (11) queries the TLS Crawler for a status and quality assessment service, called a declaration request (33,34,35), and after processing in the invented crawler mechanism, SMS2 (11) gets back a yes or no answer, together with quality indicators, optionally stated by the sender in the Declaration request (33,34,35).

The TLS Crawler is a server which operates in two different modes; search mode or pre-defined. In search mode the TLS Crawler finds available receivers for a given message transport (e.g., receiving mail servers). In pre-defined mode the TLS Crawler checks exactly the server address or domain name given as a parameter (e.g., xx@my-company.com). Independent of operational mode the result from the TLS Crawler is a quality statement of the security settings of the receiver (i.e., receiving server). The quality statement reported back to the sender can be simple (e.g., yes or no for a given security threshold) or complex (e.g., security parameters like crypto algorithms, keylengths, certificates and traffic data like when tested, response time, DNS changes etc.) The TLS Crawler uses an internal database for storing all (i.e., complex) receiver information. To be able to give a simple response to the sender, the TLS Crawler must know the security threshold of the sender. The threshold can be pre-defined as a configuration in the TLS Crawler or threshold can be sent by the sender as a configuration request. One sender can have multiple thresholds and each threshold for a given sender is identified by a number in the simple response request to the TLS Crawler.

### ONE MODE FOR CARRYING OUT THE INVENTION

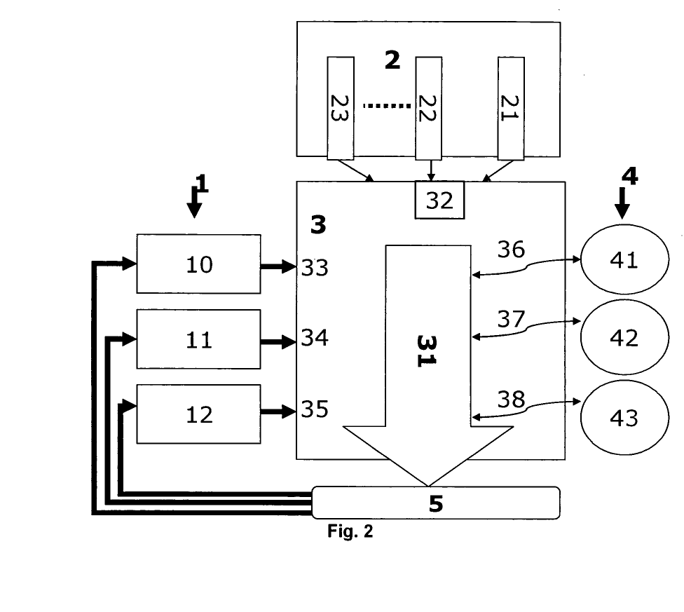

One mode for carrying out the invention will now be explained with support from FIG. 2.

1. The sender (1) sends a Declaration request (33,34,35)
a. A Declaration request (33,34,35) is an electronically sent message request from the sender (1) that asks:
   If any TLS connection is available for a given receiver (4), specified by the receivers address, e.g. a SMTP, HTTP, NNTP or other address that use TLS for security.
   The Declaration request may include security requirements as parameters to the request.
   The Declaration request (33,34,35) might be delivered by any suitable, open standard protocol such as HTTP, SMTP, LDAP, SAML or proprietary protocols.

2. The TLS Crawler (3) verifies the messaging server address
a. A Verification of the receivers (4) messaging service is an electronically sent message from the TLS Crawler (3) to a Domain Name Server—DNS (2) that holds the addressing details of the receivers (4) messaging service and asks for:
   The servers name of the machine that runs the messaging (4) service.
   The IP address that is associated to the machine in question
b. When required data (32) is retrieved from the DNS (2), the data is stored in a TLS Crawler database (3).
c. If the IP address or the related machine name already exists in the database, a compare operation checks if this database entry is inconsistent with the latest obtained information from the DNS. If there are changes, TLS Crawler (3) will produce an electronically sent message alert that will be embedded in the Declaration response (5), described below.

3. The TLS Crawler (3) verifies the quality of the TLS connection
a. A TLS challenge-response as defined in the TLS standard is initiated by the TLS Crawler (3) and sent to the IP address of the messaging server (4) on the receiving site, currently retrieved from the DNS, which will result in either a fully processed TLS connection or not.
b. If no TLS connection was processed or available, an electronically sent message is produced to indicate this state in the Declaration response (5), described below.
c. If a successful TLS connection is the result, TLS Crawler retrieves the receiving sites' (4) TLS certificate. TLS Crawler (3) may validate the certificate and assess the quality, based on the senders trust of the issuer, (e.g. if it is self-signed or not), and produce an electronically message that relates to the optionally parameters of quality stated in the senders Declaration request (33,34,35).

4. The TLS Crawler response (5)
a. A TLS Crawler response (5) is electronically message sent to the senders messaging service (1). The response is assembled as a result of processes described above and delivered using any suitable open protocol such as LDAP, SAML, HTTP, SMTP or proprietary protocols.
b. A mandatory parameter in the response is whether or not a TLC connection is currently available towards the receivers messaging service (4).
c. Several optionally parameters in the response might be delivered, based on two classes:
   i. Optional parameters stated by the sender (1) in the request, such as a requirement for a validated certificate issued by a given commercial certificate authority.
   ii. Optional parameters generated by the TLS Crawler (3), such as a security alert, e.g. produced as a. result of suspicious or probable man-in-the-middle attack.

### GUIDE TO NUMERALS USED IN THE FIGURES

1 Senders

10 Sending message service 1, security policy A

11 Sending message service 2, security policy B

12 Sending message service 3, security policy C

2 Domain Name Server (DNS)

21 Receiving server 1

22 Receiving server 2

23 Receiving server 3

3 TLS crawler according to the present invention

31 TLS crawler status and quality assessment

32 Retrieval of DNS info about receiving server (21, 22, 23)

33, 34, 35 Declaration request

36, 37, 38 TLS check

4 Receivers

41 Receiving messaging service 1

42 Receiving messaging service 2

43 Receiving messaging service 3

5 Response, declared/Not declared TLS connection

1. An apparatus for declaration of security level of transport paths/routes in one or more data networks comprising:
an entity configured to obtain addressing details of nodes in said at least one data network and to interrogate said nodes with respect to said nodes security level and/or said nodes possessed certificates in response to receiving a request for a declaration,
the entity being further configured to communicate with at least one database where said database includes information about strength of certificates and issuers of certificates,
the entity having at least a mechanism configured to retrieve the addressing details of the nodes from domain name servers, and
the entity further having an interface configured to receive the request for the declaration from one or more senders.

2. A method for declaration of security level of transport paths/routes in one or more data networks, where the network comprises, at least one or more senders, at least one or more receivers, at least one or more intermediate nodes characterized in that the method at least comprise the steps of:
a) the at least one or more sender sending a declaration request to an entity,
b) the entity verifying the at least one receivers messaging service address, by;
interrogating a domain name server having access to the addressing details of the at least one receiver messaging service address with respect to server names of the machines that runs at least one messaging services and the address associated with it, or
interrogating a database or storage means accessible to the entity where the database or storage means have access to the addressing details of the at least one receiver messaging service address with respect to server names of the machines that runs the at least one messaging services and the address associated with it, and
c) the entity verifying the security level or level of confidentiality of a one or more connections requested by the at least one sender, and
d) the entity sending a response to the one or more senders.

3. A method according to claim 2, characterized in that the declaration request in step a further comprises inquiring regarding;
if a requested level of security is available for the one or more receivers,
if the current secure connection accommodates security requirements, optionally stated by the sender.

4. A method according to claim 2, characterized in that step b further comprises the steps of storing data retrieved from the domain name server in a database accessible to the entity.

5. A method according to claim 4, characterized in that if the address or related machine name already exists in the database accessible to the entity comparing whether said database entry is consistent with the latest information obtained from the domain name server, if inconsistency exists producing at the entity an alert signal.

6. A method according to claim 2, characterized in that step c further comprises the steps of:
producing a challenge for revealing the level of security of a challenged part and to prepare connection to the challenged part if the level of security is in accordance with the challenge,
forwarding the challenge to the address of the messaging server, and
if requested level of security is not available, producing a message indicating that the requested level of security is unavailable at the one or more receiver, or
if requested level of security is available, the entity retrieving the one or more receivers one or more certificates and producing a message indicating that the requested level of security were available at the one or more receiver.

7. A method according to claim 6, characterized in that if the requested level of security were available, the entity validating the certificates and assesses the quality based on the one or more senders trust of the issuer.

8. A method according to claim 6 characterized in that the message produced by the entity is forwarded to the one or more senders.

9. A method according to claim 7, characterized in that the message produced by the entity is forwarded to the one or more senders.

10. A method for declaration of security level of transport paths/routes in one or more data networks comprising:
responding to a request from a sender for a declaration of a level of security available in a network connection to a receiver;
retrieving a network address of the receiver from a domain name server in response to the request;
initiating a secure connection to the receiver by issuing a challenge to the network address of the receiver;
retrieving a certificate associated with the receiver in response to a secure connection to the receiver resulting from the challenge; and
sending the declaration to the sender indicating the level of security available in the network connection to the receiver resulting from the challenge.

11. new) The method of claim 10 further defined by the declaration indicating non-availability or availability of a secure network connection to the receiver resulting from the challenge.

12. The method of claim 10 further defined by the entity validating the certificate and the declaration indicating a quality of the certificate based upon whether the certificate is self-signed or not self-signed.

13. The method of claim 10 further defined by the declaration providing security parameters or indicating whether a security threshold is met.

14. The method of claim 10 further defined by:
the entity communicating with a crawler database;
the entity storing addresses or machine names of receivers in the crawler database and comparing the stored addresses or machine names with the network address of the receiver retrieved from the domain name server.

15. The method of claim 14 further comprising the entity sending a message alert in the declaration in response to an inconsistency between the stored addresses or machine names and the retrieved network address of the receiver.
